(19) United States
(12) Patent Application Publication
(10) Pub. No.: US 2025/0182000 A1
(43) Pub. Date: Jun. 5, 2025

(54) POINT-OF-TIME CALCULATION APPARATUS, POINT-OF-TIME CALCULATION METHOD, AND PROGRAM

(71) Applicant: NIPPON TELEGRAPH AND TELEPHONE CORPORATION, Tokyo (JP)

(72) Inventors: Masahiro SOTOMA, Tokyo (JP); Machiko SHINOZUKA, Tokyo (JP); Xiaoxi ZHANG, Tokyo (JP); Midori KAWADA, Tokyo (JP); Minako HARA, Tokyo (JP)

(21) Appl. No.: 18/843,846

(22) PCT Filed: Apr. 18, 2022
(86) PCT No.: PCT/JP2022/018030

§ 371 Date: Sep. 4, 2024

(51) Int. Cl. G06Q 10/04; G01W 1/10; G06Q 40/04

(52) U.S. Cl. CPC G06Q 10/04; G01W 1/10; G06Q 40/04

(57) ABSTRACT

An object of the present disclosure is to clarify a timing at which at least two prediction values as comparison targets start to increase to be more than a predetermined value or deviate to be equal to or more than a predetermined value when a future event that exhibits chaotic behavior or is likely to exhibit the chaotic behavior is predicted.

Therefore, the present disclosure provides a timing calculation device including an input unit that inputs a first initial value and a second initial value necessary for predicting a future event that exhibits chaotic behavior or is likely to exhibit the chaotic behavior, a prediction value calculation unit that calculates a first prediction value of the event with respect to the first initial value and calculates a second prediction value of the event with respect to the second initial value, a deviation value calculation unit that calculates a deviation value from a difference between the first prediction value and the second prediction value, a timing calculation unit that calculates a timing at which the deviation value becomes more than a deviation threshold value or a predetermined timing at which the deviation value becomes equal to or more than the deviation threshold value, and an output unit that outputs information regarding the predetermined timing.

### TECHNICAL FIELD

The present disclosure relates to a technique of calculating a timing when a prediction value deviating from a predetermined value can be adopted.

### BACKGROUND ART

There are many prediction techniques using numerical calculation and the like. On the other hand, in an event exhibiting chaotic behavior such as weather, it is known that a prediction value greatly varies due to a slight difference in an initial value input to a prediction model.

In view of this problem, for example, in weather prediction, each prediction value is obtained as time-series data by using different initial values, a variation range of the prediction value is clarified to show that prediction uncertainty increases in the farther future. In this state, the prediction value is used in the real world (see Non Patent Literature 1).

### CITATION LIST

### Non Patent Literature

Non Patent Literature 1: Roberto Buizza, 2002, Chaos and weather prediction, European Centre for Medium-Range Weather <https://www.ecmwf.int/file/47912/download?token=Qx-OYr4e>

### SUMMARY OF INVENTION

### Technical Problem

However, not only in the case of weather prediction, but also in the case of prediction of a future event that exhibits chaotic behavior or is likely to exhibit the chaotic behavior, when it is not possible to set the initial value deterministically and uniquely, a similar problem occurs. In many cases, the influence of a difference in the initial value on the prediction value rapidly increases from a certain timing (time point). That is, although there is no relatively large difference for a while from the start of prediction, the prediction value starts to deviate rapidly at a certain timing. For example, in a case where a prediction model allows a certain range of the prediction value, it is important to ascertain a timing at which the prediction value starts to deviate rapidly. This is because it then becomes possible to clearly show information for determining the temporal use range of the prediction model, for example.

The present invention has been made in view of the above points, and an object of the present invention is to clarify a timing at which at least two prediction values as comparison targets start to increase to become more than a predetermined value or deviate to be equal to or more than a predetermined value when a future event that exhibits chaotic behavior or is likely to exhibit the chaotic behavior is predicted.

### Solution to Problem

In order to solve the above problem, according to a first aspect of the present invention, a timing calculation device includes an input unit that inputs a first initial value and a second initial value that are necessary for predicting a future event that exhibits chaotic behavior or is likely to exhibit the chaotic behavior, a prediction value calculation unit that calculates a first prediction value of the event with respect to the first initial value and calculates a second prediction value of the event with respect to the second initial value, a deviation value calculation unit that calculates a deviation value from a difference between the first prediction value and the second prediction value, a timing calculation unit that calculates a timing at which the deviation value becomes more than a deviation threshold value or a predetermined timing at which the deviation value becomes equal to or more than the deviation threshold value, and an output unit that outputs information regarding the predetermined timing.

### Advantageous Effects of Invention

According to the present invention described above, it is possible to exhibit an effect that it is possible to clarify a timing at which at least two prediction values as comparison targets start to increase to be more than a predetermined value or deviate to be equal to or more than a predetermined value when a future event that exhibits chaotic behavior or is likely to exhibit the chaotic behavior is predicted.

### BRIEF DESCRIPTION OF DRAWINGS

FIG. 1 is a schematic diagram of a communication system.

FIG. 2 is an electrical hardware configuration diagram of a timing calculation device.

FIG. 3 is an electrical hardware configuration diagram of a communication terminal.

FIG. 4 is a functional configuration diagram of a timing calculation device according to an embodiment.

FIG. 5 is a flowchart illustrating processing of calculating a timing at which deviation starts due to a difference in an initial value.

FIG. 6 is a diagram illustrating time-series trajectories of prediction values output in a case where different initial values are input to a prediction model.

FIG. 7 is a diagram illustrating a plot example of the initial value and n mainly meaning an elapse of time.

### DESCRIPTION OF EMBODIMENTS

Hereinafter, an embodiment of the present invention will be described with reference to the drawings.

### System Configuration of Embodiment

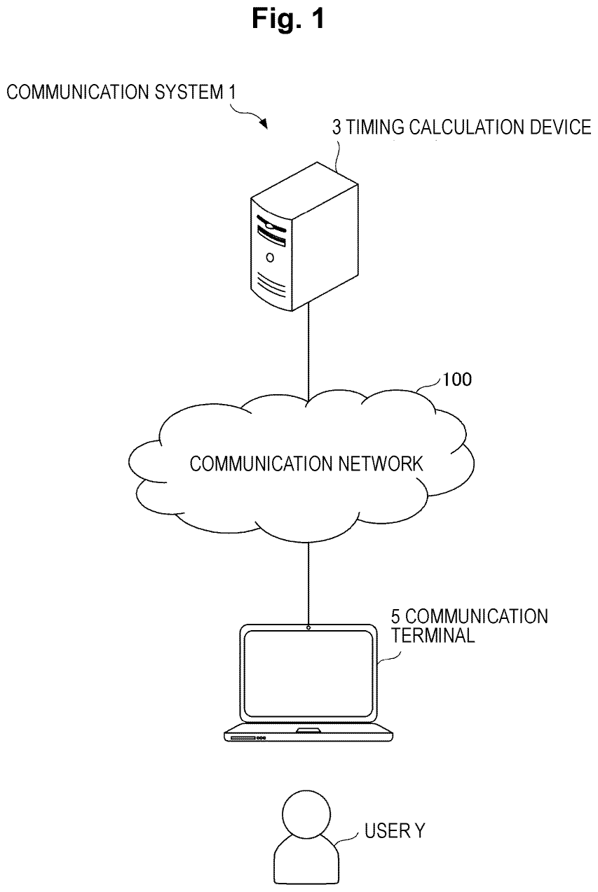

First, an outline of a configuration of a communication system according to the present embodiment will be described with reference to FIG. 1. FIG. 1 is a schematic diagram of the communication system according to the embodiment of the present invention.

As illustrated in FIG. 1, a communication system 1 in the present embodiment is constructed by a timing calculation device 3 and a communication terminal 5. The communication terminal 5 is managed and used by a user Y. The user is a person who determines until which timing (including a “time point”) in the future a prediction value will be adopted, with reference to an output result of the timing calculation device.

The timing calculation device 3 and the communication terminal 5 can communicate with each other via a communication network 100 such as the Internet. The connection form of the communication network 100 may be either wireless or wired.

The timing calculation device 3 includes one or a plurality of computers. In a case where the timing calculation device 3 includes a plurality of computers, the timing calculation device 3 may be referred to as a “timing calculation device” or a “timing calculation system”.

The timing calculation device 3 predicts a future event that exhibits chaotic behavior or is likely to exhibit the chaotic behavior and calculates a timing at which at least two prediction values as comparison targets start to increase to be more than a predetermined value or deviate to be equal to or more than a predetermined value. Examples of the event that exhibits chaotic behavior or is likely to exhibit the chaotic behavior include weather prediction, stock price prediction, and the like.

The communication terminal 5 is a computer, and FIG. 1 illustrates a laptop personal computer as an example. In FIG. 1, the user Y operates the communication terminal 5. Note that the processing may be performed by the timing calculation device 3 alone without using the communication terminal 5.

### [Hardware Configuration]

<Hardware configuration of Timing Calculation Device>

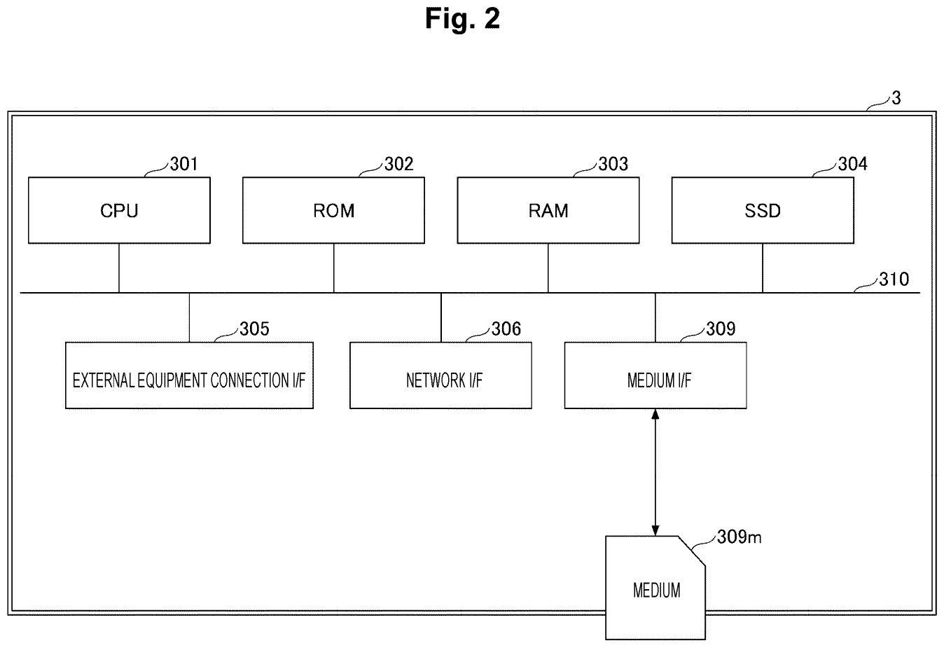

Next, an electrical hardware configuration of the timing calculation device 3 will be described with reference to FIG. 2. FIG. 2 is an electrical hardware configuration diagram of the timing calculation device.

As illustrated in FIG. 2, the timing calculation device 3 includes, as a computer, a central processing unit (CPU) 301, a read only memory (ROM) 302, a random access memory (RAM) 303, a solid state drive (SSD) 304, an external equipment connection interface (I/F) 305, a network I/F 306, a medium I/F 309, and a bus line 310.

Among the components, the CPU 301 controls an operation of the entire timing calculation device 3. The ROM 302 stores a program used for driving the CPU 301, such as an initial program loader (IPL). The RAM 303 is used as a work area of the CPU 301.

The SSD 304 reads or writes various data under the control of the CPU 301. Note that a hard disk drive (HDD) may be used instead of the SSD 304.

The external equipment connection I/F 305 is an interface for connecting various types of external equipment. Examples of the external equipment in this case include a display, a speaker, a keyboard, a mouse, a universal serial bus (USB) memory, and a printer.

The network I/F 306 is an interface for performing data communication via the communication network 100.

The medium I/F 309 controls reading or writing (storing) of data with respect to a recording medium 309m such as a flash memory. Examples of the recording medium 309m also include a digital versatile disc (DVD), a Blu-ray Disc (registered trademark), and the like.

The bus line 310 is an address bus, a data bus, or the like for electrically connecting the respective components such as the CPU 301 illustrated in FIG. 2.

### <Hardware Configuration of Communication Terminal>

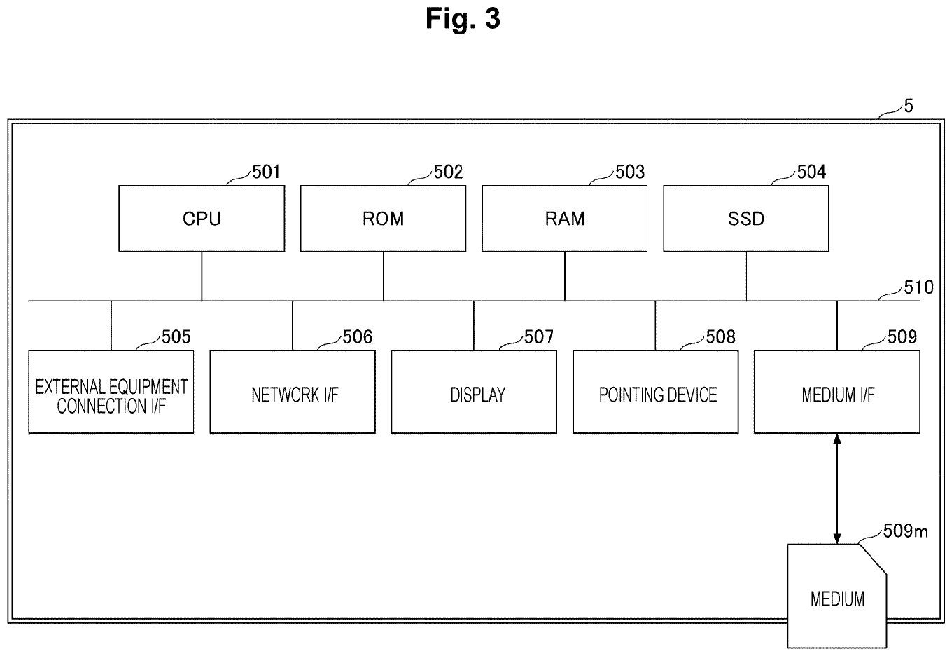

Next, an electrical hardware configuration of the communication terminal 5 will be described with reference to FIG. 3. FIG. 3 is an electrical hardware configuration diagram of the communication terminal.

As illustrated in FIG. 3, the communication terminal 5 includes, as a computer, a CPU 501, a ROM 502, a RAM 503, an SSD 504, an external equipment connection interface (I/F) 505, a network I/F 506, a display 507, a pointing device 508, a medium I/F 509, and a bus line 510.

Among the components, the CPU 501 controls the operation of the entire communication terminal 5. The ROM 502 stores a program used for driving the CPU 501 such as IPL. The RAM 503 is used as a working area of the CPU 501.

The SSD 504 reads or writes various types of data under the control of the CPU 501. Note that a hard disk drive (HDD) may be used instead of the SSD 504.

The external equipment connection I/F 505 is an interface for connecting various types of external equipment. Examples of the external equipment in this case include a display, a speaker, a keyboard, a mouse, a USB memory, and a printer.

The network I/F 506 is an interface for performing data communication via the communication network 100.

The display 507 is a type of display means such as liquid crystal or organic electro luminescence (EL) that displays various images.

The pointing device 508 is a type of input means that performs selection and execution of various instructions, selection of a processing target, movement of a cursor, and the like. Note that, in a case where the user Y uses a keyboard, the function of the pointing device 508 may be turned off.

The medium I/F 509 controls reading or writing (storing) of data with respect to a recording medium 509m such as a flash memory. The recording medium 509m also includes a DVD, a Blu-ray Disc (registered trademark), and the like.

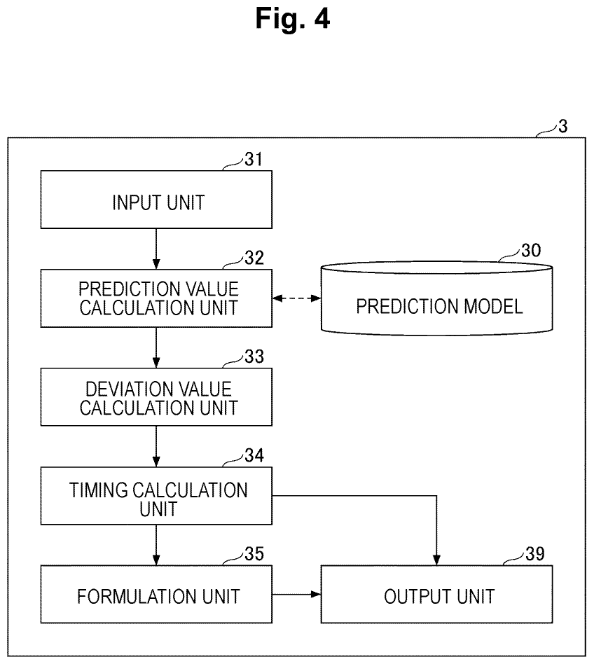

The bus line 510 is an address bus, a data bus, or the like for electrically connecting each component such as the CPU 501 illustrated in FIG. 4.

### [Functional Configuration of Timing Calculation Device]

Next, a functional configuration of the timing calculation device will be described with reference to FIG. 4. FIG. 4 is a functional configuration diagram of the timing calculation device in the embodiment.

In FIG. 4, the timing calculation device 3 includes an input unit 31, a prediction value calculation unit 32, a deviation value calculation unit 33, a timing calculation unit 34, a formulation unit 35, and an output unit 39. Each of these units is a function realized by a command by the CPU 301 in FIG. 2 based on a program.

### <Prediction Model>

In the RAM 303 or the SSD 304 of FIG. 2, a prediction model 30 used to predict a future event that exhibits chaotic behavior or is likely to exhibit the chaotic behavior is constructed. The form and the creation method of the prediction model 30 are not limited.

Here, the logistic mapping is used as the prediction model 30 for description, and the definition expression is shown in (Expression 1).

$$[ Math . 1 ]$$

$${x}_{n + 1} = r * {x}_{n} * ( 1 - {x}_{n} ) \qquad ( Expression 1 )$$

It is assumed that a parameter r is included as a constituent element of the prediction model 30. The prediction model 30 is a time-series model, and prediction is calculated by using a previous prediction value. That is, in (Expression 1), n means the number of calculations, but in a case where the prediction model is other than (Expression 1), n may be information (indicated as “elapsed time-related information T”) having a time point or the elapsed time from a certain time point, and the equivalent meanings to the elapsed time such as the number of rotations, the number of times of on/off, and the number of observations.

Note that, here, for convenience of description, one parameter r is used, but an expression including a plurality of parameters may be used. Furthermore, although the prediction model 30 is shown as one expression, a model form of machine learning such as a neural network may be used.

### <Each Functional Component>

Subsequently, functional components of the timing calculation device will be described with reference to FIGS. 2 and 4.

The input unit 31 inputs setting values such as at least a first initial value and a second initial value to the prediction model from the user Y via the communication terminal 5 and the network I/F 306.

Using the prediction model 30, the prediction value calculation unit 32 calculates a first prediction value of a future event with respect to the first initial value, and calculates a second prediction value of the future event with respect to the second initial value.

The deviation value calculation unit 33 calculates a deviation value from a difference between the first prediction value and the second prediction value.

The timing calculation unit 34 calculates a timing at which the deviation value becomes more than a deviation threshold value or a predetermined timing at which the deviation value becomes equal to or more than the deviation threshold value.

The formulation unit 35 formulates a variation in a timing at which the prediction value starts to deviate. That is, the formulation unit 35 formulates a relationship between changes in the first initial value and the second initial value and the elapsed time-related information T indicating the elapsed time to the future or indicating information related to the elapsed time.

The output unit 39 outputs information regarding the predetermined timing calculated by the timing calculation unit 34. Furthermore, the output unit 39 outputs information of a result obtained by formulation of the formulation unit 35. Examples of the output method include transmission of output result data to the communication terminal 5 via the network I/F 506, display on an external display via the external equipment connection I/F 505, and printing by a printing device or the like via the external equipment connection I/F 505.

### Processing or Operation of Embodiment

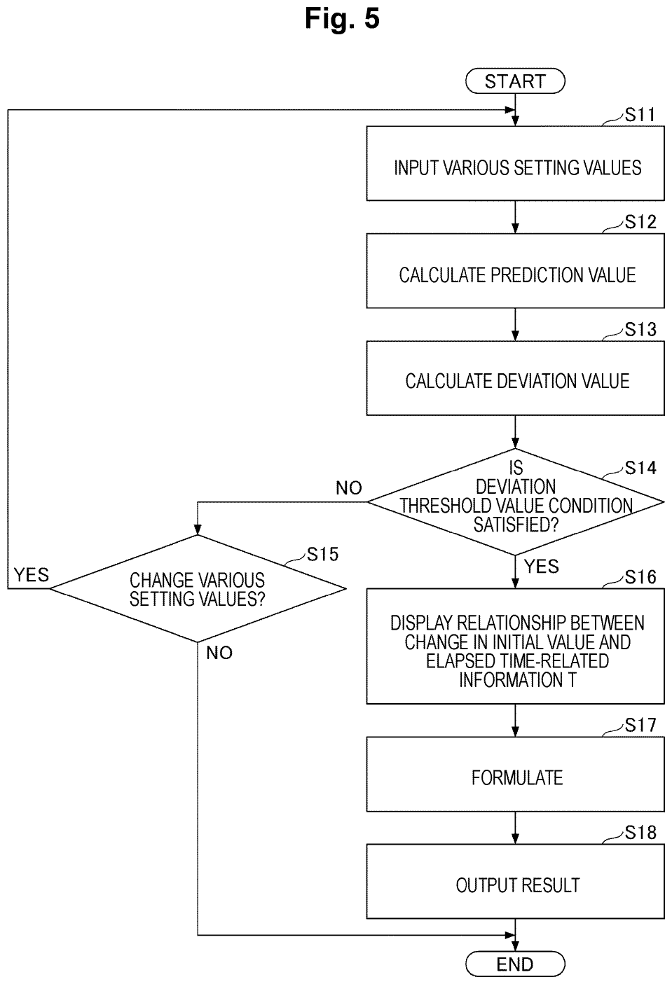

Subsequently, the processing or the operation of the present embodiment will be described in detail with reference to FIGS. 5 to 7. FIG. 5 is a flowchart illustrating processing of calculating the timing at which deviation starts due to the difference in the initial value.

S11: The input unit 31 inputs various setting values (first initial value, second initial value, and the like) necessary for processing, from the communication terminal 5 or the like.

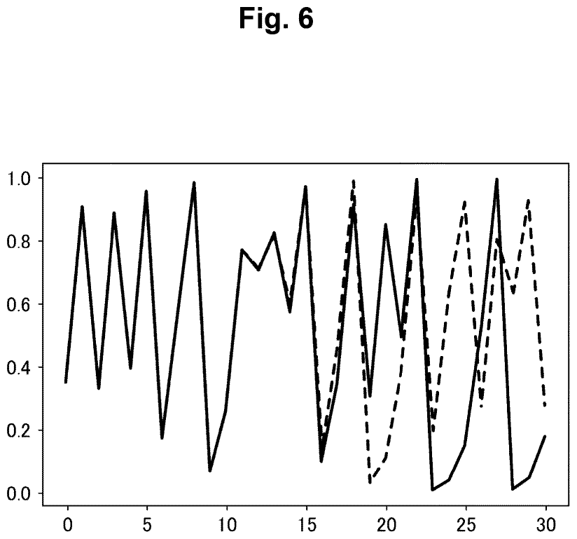

S12: The prediction value calculation unit 32 calculates each prediction value by inputting each initial value input by the input unit 31 to the prediction model 30 and outputting each prediction value. Here, the process of Step S12 will be described in detail with reference to FIG. 6. FIG. 6 is a diagram illustrating time-series trajectories of prediction values output in a case where different initial values are input to the prediction model.

FIG. 6 illustrates a trajectory drawn by the prediction model in a case where there is a slight difference between r=a and the initial value x₀ (n=0) in (Expression 1). In FIG. 6, the horizontal axis represents the value of n in (Expression 1), and the vertical axis represents the value of x in (Expression 1). In addition, the solid line represents a trajectory when the initial value x₀ is given to the prediction model 30, and the broken line represents a trajectory when a value α a much smaller than the initial value x₀ is added to the prediction model 30. The two trajectories exhibit substantially the same motion for some time, but quickly deviates from a certain time point. The setting range of the initial value is obtained from a target event, or an initial value width desired to be checked by the user Y is freely set, and a representative value of x₀ is selected from the range. This representative value is defined as X. As the representative value X, a median value or the like of the setting range may be automatically adopted, or may be manually set as appropriate.

Note that the representative value is an example of the first initial value, and an initial value other than the representative value is an example of the second initial value.

S13: The deviation value calculation unit 33 calculates the deviation value by using the prediction value calculated by the prediction value calculation unit 32. The deviation value is obtained, for example, by taking a difference between the representative value X (first initial value) of the initial value and each initial value Xₙ calculated with each initial value (second initial value) other than the representative value X. Alternatively, in a case where there are a plurality of second initial values, the deviation value may be calculated by another calculation method such as an average value or a sum of the deviation values of the plurality of initial values Xₙ.

S14: The timing calculation unit 34 determines whether or not the deviation value calculated by the deviation value calculation unit 33 satisfies a deviation threshold value condition. In this case, the timing calculation unit 34 compares the deviation value calculated by the deviation value calculation unit 33 to the deviation threshold value set in advance, and determines that the deviation in a predetermined state has started in a case where the deviation value is more than the deviation threshold value (or in a case where the deviation value is equal to or more than the deviation threshold value). Note that the setting of the deviation threshold value may be automatically set by some method or may be manually set as appropriate.

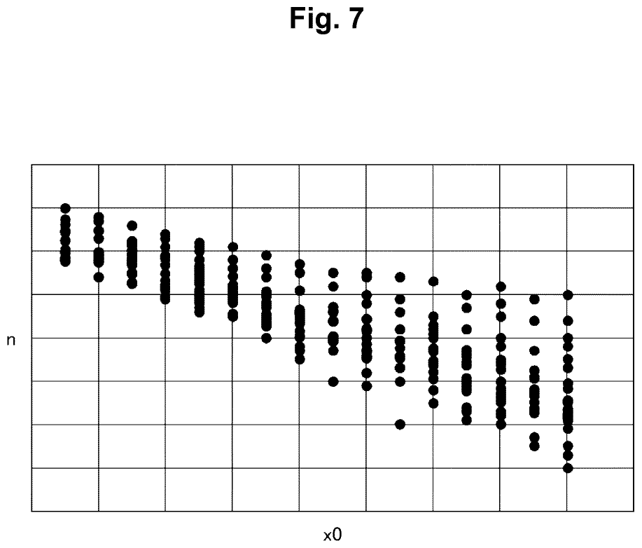

The timing calculation unit 34 repeats the calculation in Step S14 in a range where the parameter r can be taken. As a result, a set of n in which the prediction value starts to deviate is obtained in a range where the parameter r and the initial value x₀ can be taken. FIG. 7 is a diagram illustrating a plot example of the initial value and n mainly meaning an elapse of time. FIG. 7 illustrates an example of a plot of n in (Expression 1). The horizontal axis represents x₀, and the vertical axis represents n.

The timing calculation unit 34 proceeds to Step S15 in a case where it is determined that the deviation value does not satisfy the deviation threshold value condition, and proceeds to Step S16 in a case where it is determined that the deviation value satisfies the deviation threshold value condition.

S15: The timing calculation unit 34 determines whether or not to change various setting values. In a case where the timing calculation unit 34 determines to change the various setting values, the process returns to Step S11, and the input unit 31 changes the various setting values. Then, the subsequent processes are executed. On the other hand, in a case where the timing calculation unit 34 determines not to change the various setting values, the processing illustrated in FIG. 5 is ended.

S16: The output unit 39 outputs information of a graph or the like (see FIG. 7) indicating the relationship between the change in the initial value and the elapsed time-related information T. As a result, the user Y can view the information such as the graph, and thus, it is possible to deepen the understanding of the user Y. Note that Step S16 may be omitted.

S17: The formulation unit 35 formulates the relationship between the change in the initial value and the elapsed time-related information T. Specifically, the formulation unit 35 formulates a relationship between the parameter r, the initial values x₀, and n. Any method or function may be used for the formulation. A multi-dimensional simultaneous distribution with respect to n may be used. For example, a two-dimensional simultaneous distribution of the initial values x₀ and n may be obtained for each combination with n.

S18: The output unit 39 outputs a result obtained by formulation of the formulation unit 35.

### Effects of Embodiment

According to the present embodiment described above, it is possible to exhibit an effect that it is possible to clarify a timing at which at least two prediction values as comparison targets start to increase to be more than a predetermined value or deviate to be equal to or more than a predetermined value when a future event that exhibits chaotic behavior or is likely to exhibit the chaotic behavior is predicted. As a result, it is possible to exhibit an effect that the user Y can easily determine until which timing the prediction value is adopted.

### [Supplementary Notes]

The present invention is not limited to the above embodiment and may be configured or processed (operated) as described below.

(1) The timing calculation device 3 can also be implemented by a computer and a program, but the program may be recorded on a (non-transitory) recording medium or provided via the communication network 100.

(2) In communication between the timing calculation device 3 and the communication terminal 5, another device (server, router, and the like) may relay data. For example, in the present specification, for the simplicity, it is described that the input unit 31 of the timing calculation device 3 transmits the data to the communication terminal 5, but this transmission processing includes a case where another device relays the data.

(3) In the above embodiment, a laptop personal computer is shown as an example of the communication terminal 5, but the communication terminal 5 is not limited to this, and may be, for example, a desktop personal computer, a tablet terminal, a smartphone, a smartwatch, a car navigation device, a refrigerator, a microwave oven, or the like.

(4) Each of the CPUs 301 and 501 may be not only a single CPU but also a plurality of CPUS.

### REFERENCE SIGNS LIST

1 Communication system
3 Timing calculation device
5 Communication terminal
30 Prediction model
31 Input unit
32 Prediction value calculation unit
33 Deviation value calculation unit
34 Timing calculation unit
35 Formulation unit
36 Output unit

1. A timing calculation device comprising:
a processor; and
a memory storing program instructions that cause the processor to:
input a first initial value and a second initial value that are necessary for predicting a future event that exhibits chaotic behavior or is likely to exhibit the chaotic behavior;
calculate a first prediction value of the event with respect to the first initial value and calculates a second prediction value of the event with respect to the second initial value;
calculate a deviation value from a difference between the first prediction value and the second prediction value;
calculate a timing at which the deviation value becomes more than a deviation threshold value or a predetermined timing at which the deviation value becomes equal to or more than the deviation threshold value; and
output information regarding the predetermined timing.

2. The timing calculation device according to claim 1, wherein the program instructions further cause the processor to
formulate a relationship between a change in the first initial value and the second initial value and elapsed time-related information indicating an elapsed time into future or indicating information related to the elapsed time,
and output information of a result obtained by the formulation.

3. The timing calculation device according to claim 1, wherein the program instructions further cause the processor to calculate the first prediction value and the second prediction value by using a prediction model that receives an input of the initial value and outputs the prediction value.

4. The timing calculation device according to claim 3, wherein the prediction model is a machine learning model based on a neural network.

5. The timing calculation device according to claim 1, wherein the event is weather prediction or stock price prediction.

6. A timing calculation method comprising:
inputting a first initial value and a second initial value that are necessary for predicting a future event that exhibits chaotic behavior or is likely to exhibit the chaotic behavior;
calculating a first prediction value of the event with respect to the first initial value and calculating a second prediction value of the event with respect to the second initial value;
calculating a deviation value from a difference between the first prediction value and the second prediction value;
calculating a timing at which the deviation value becomes more than a deviation threshold value or a predetermined timing at which the deviation value becomes equal to or more than the deviation threshold value; and
outputting information related to the predetermined timing.

7. A non-transitory computer-readable recording medium having stored therein a program for causing a computer to execute the method according to claim 6.
